(19) United States
(12) Patent Application Publication
(10) Pub. No.: US 2014/0372745 A1
(43) Pub. Date: Dec. 18, 2014

(54) BOOTING A SERVER USING A REMOTE READ-ONLY MEMORY IMAGE

(71) Applicants: Richard Wei Chieh Yu, Spring, TX (US); Terry T. Haas, Tomball, TX (US); Erik Levon Young, Houston, TX (US)

(72) Inventors: Richard Wei Chieh Yu, Spring, TX (US); Terry T. Haas, Tomball, TX (US); Erik Levon Young, Houston, TX (US)

(21) Appl. No.: 14/362,566

(22) PCT Filed: Jan. 30, 2012
(86) PCT No.: PCT/US2012/023113

§ 371 Date: Jun. 3, 2014

(51) Int. Cl. G06F 9/44

(52) U.S. Cl. CPC G06F 9/4416
USPC 713/2

(57) ABSTRACT

Systems, methods, and computer-readable and executable instructions are provided for booting a server using a remote read-only memory image. Booting a server using a remote read-only memory (ROM) image can include accessing a remote ROM image from a second server for the first server, wherein the first server does not have a complete ROM image 102, and storing the image in a subsystem memory 104. Booting a server using a remote ROM image can include booting the first server from the remote ROM image in the subsystem memory 106.

### BACKGROUND

Powering up a device can require many functions to place the device into an operational state. These functions are commonly referred to as “boot-up”, “booting”, “booting up”, etc. A booting procedure may be well defined for any given device, and the booting procedures may vary from device to device. Booting up a device may include the use of a read-only memory image stored in an embedded storage device, typically called a read-only memory boot image.

### BRIEF DESCRIPTION OF THE DRAWINGS

FIG. 1 is a flow chart illustrating an example method for booting a server using a remote read-only memory (ROM) image, according to the present disclosure.

FIG. 2 is a flow chart illustrating an example of a process for booting a server using a ROM image, according to the present disclosure.

FIG. 3 illustrates a block diagram of an example of a system for booting a server using a remote ROM image, according to the present disclosure.

### DETAILED DESCRIPTION

Examples of the present disclosure include methods, systems, and computer-readable executable instructions and/or logic. Methods for booting a server using a remote read-only memory (ROM) image can include accessing a remote ROM image from a second server for the first server, wherein the first server does not have a complete ROM image; storing the remote ROM image in a subsystem memory; and, booting the first server from the remote ROM image in the subsystem memory.

Booting a server in a network system can result in many devices in a network system being managed by one server, and the network may have numerous servers to manage all network devices. Each managing server can include an embedded storage device to store the ROM boot image that can be used for booting the server. An embedded storage device can include a storage device (e.g. a flash memory) that is embedded as part of a larger device and/or system (e.g. a server). Embedded storage devices can be dedicated to perform one or a few particular functions within the larger device and/or system.

For example, a flash memory can be embedded on the hardware of a server and used to store the boot ROM image to boot the server. Booting a server can include powering up the server such that the server is in an operational state.

Updating the ROM image for all servers in a network can require updating each individual ROM image stored in an embedded storage device of each server in the networks. By implementing a boot procedure for a server in a network using a remote ROM image stored in a centralized network server, the ROM image for the entire network system can be updated by updating the single ROM image stored in the centralized server. The individual servers in a network system can run with the updated ROM image in the next reboot once the centralized ROM image is updated. And, the network servers may not require an embedded storage device for booting.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

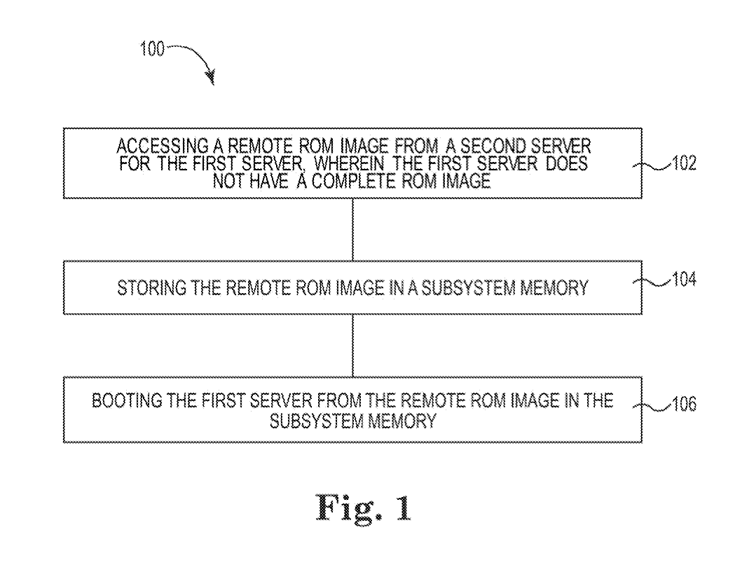

FIG. 1 is a flow chart illustrating an example method 100 for booting a server using a remote ROM image, according to the present disclosure. The method 100 can boot numerous servers in a network with a single remote ROM image that is stored on a centralized server in the network.

At 102, a remote ROM image is accessed from a second server for the first server, wherein the first server does not have a complete ROM image. Accessing can include contacting the second server and detecting the remote ROM image, among many others. A remote ROM image can include a ROM image that is not located on an embedded storage device of the first server, for example. The remote ROM image can be stored on the second server. A ROM image can include nonvolatile instructions to boot a device, for example. Nonvolatile instructions can include instructions that are retained on the device storage when the device is powered off. The second server can be for example, in the network of the first server. The second server can include a remote server, a remote web server, a File Transfer Protocol (FTP) server, or a network file system server, such as Network File System (NFS) or Common Internet File System (CIFS), among many others.

The first server not having a complete ROM image can include the first server not having a ROM image that can boot the first server to a fully operable state. In some examples of the present disclosure, the method can include using a pre-validated ROM image stored on the subsystem memory to begin booting the first server. The pre-validated ROM image can include a ROM image that is smaller than the remote ROM image, for example. The pre-validated ROM image can include a ROM image that can begin the boot process for the first server but is insufficient to complete the boot process, or example.

In various examples of the present disclosure, accessing the remote ROM image can include retrieving configuration information associated with the boot operation of the first server. The configuration information can be stored on a baseboard management controller (BMC) located on the first server. For example, the configuration information can include BMC configuration information. The configuration information can include information associated with the boot operation of the first server and information to access the second server (e.g. host name, file path, file name, user name, password, etc.), among others. Accessing the second server can include contacting the second server, for example. The first server can access the second server using web server, FTP, or NFS protocol, among others.

At 104, the remote ROM image is stored in a subsystem memory. Storing can include loading the ROM image onto a subsystem memory, for example. For instance, a subsystem memory can include a memory on a BMC. A BMC can include a sub-device located on a device (e.g., computer, network server, hardware using sensors) that can track and monitor the state (e.g., physical state) of the device. The BMC can be located in various locations (e.g., motherboard, processor) of the device. The BMC can communicate the state of the device to a user. A user can include an administrator of a network, among others. For example, the BMC can be located on the motherboard of the first server, can track internal physical variables of the first server, and can communicate the variables to an administrator of the network. A BMC may have a separate booting process from the first server and can be capable of booting independently of the first server. For example, the BMC can boot prior to beginning the booting process for the first server.

At 106, using the remote ROM image in the subsystem memory, the first server is booted. Booting the server can include powering up the first server. The subsystem can include a BMC. Booting using a remote ROM image located on the BMC can be beneficial because the remote ROM image can be a single image centralized on a network allowing for efficient updating of a ROM image on a network and the first server may not need to have an embedded storage device to boot the first server, which can reduce the cost of the server hardware.

In various examples of the present disclosure, the method 100 can include creating a virtual ROM (VROM) on the subsystem with the remote ROM image. For example, the VROM can be created on a BMC that is located on the first server, The VROM can be created with the remote ROM image accessed from the second server.

Booting the first server can also include creating an interface on the first server to map the remote ROM image in the subsystem memory to a first server hardware. The interface can include, for example, a hardware VROM interface. The hardware VROM interface can boot the first server using the remote ROM image in the VROM with a first server hardware. The first server hardware can include hardware on the first server, for example. Thereby, the first server can boot from the remote ROM image on the subsystem using the hardware VROM interface. Booting the first server using the hardware VROM interface can be beneficial because the first server can boat from the memory of the subsystem while functioning as if booting from the physical memory of the first server.

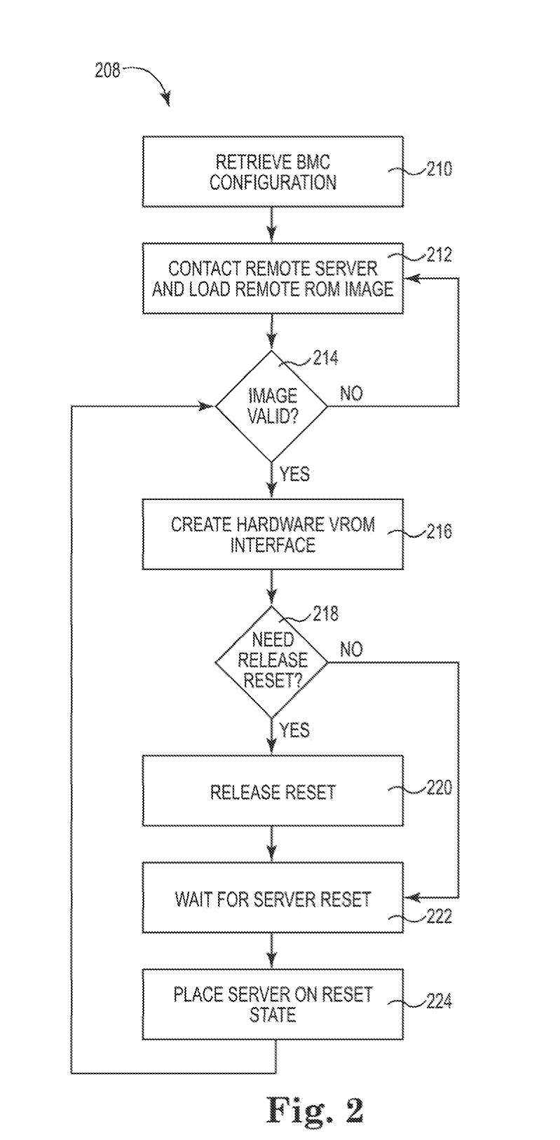

FIG. 2 is a flow chart illustrating an example of a process 208 for booting a server using a remote ROM image, according to the present disclosure.

At 210, BMC configuration information, stored on a BMC located on a server, can be retrieved. The BMC configuration information can include information associated with the boot operation of the server, for example. The server can include a server that does not have a complete ROM image on the server.

At 212, a remote server can be contacted and a remote ROM image can be loaded onto the BMC, Contacting the remote server can include detecting a remote ROM image on a remote server and accessing the remote ROM image on a remote server, for example. Accessing a remote ROM image can include accessing the remote ROM image over a network. Loading the remote ROM image onto the BMC can include loading the ROM image onto a memory on the BMC. The BMC can be located on the server.

At 214, a determination can be made as to whether the remote ROM image is valid based on the BMC configuration information. Validating the remote ROM image can include comparing the remote ROM image to the BMC configuration information to determine if the remote ROM image can be used for system boot of the server. For example, the remote ROM image can be used for system boot of the server if it is compatible with the requirements of the server. Requirements of the server can include the size of the ROM image, the server operating system, proper authorization (e.g., certificate), etc., among many others.

In response to the image not being valid, the process 208 can go back to 212 by re-contacting the remote server and re-loading a remote ROM image until the loaded remote ROM image is valid.

In response to the image being valid, at 216, a hardware VROM interface can be created. The hardware VROM interface can be used to boot the server from the remote ROM image on the BMC memory.

At 218, a determination can be made as to whether the server reset needs to be released. Releasing the server reset can include booting the server to a fully operable state. Determining if the server reset needs to be released can include determining that the server is booting when the remote ROM image is accessed, In response to a determination the server is booting and the server reset needs to be released, at 220, the server reset can be released.

In response to a determination that the server reset does not need to be released or once the server reset is released, at 222, the process can wait for the server reset. Determining that the server reset does not need to be released can include determining the server is running when the remote ROM image is accessed. A running server can include, for example, a fully operating server.

At 224, the server can be placed on a reset state in response to a server reset. A server reset can occur with or without a full system power cycle. For example, a server reset can include powering the server off and back on. Or, for example, a server reset can include a command initiated by a user, whereby the server is reset without a full system power cycle. A server reset can result in repeating the process starting at 214 by validating the remote ROM image stored on the BMC.

In some examples of the present disclosure, the location of the remote ROM image can be stored. The location of the remote ROM image can include the location of the remote ROM image on the BMC memory and the location on the remote server, among many others. Storing the location can include storing a register of the location on the BMC memory, for example.

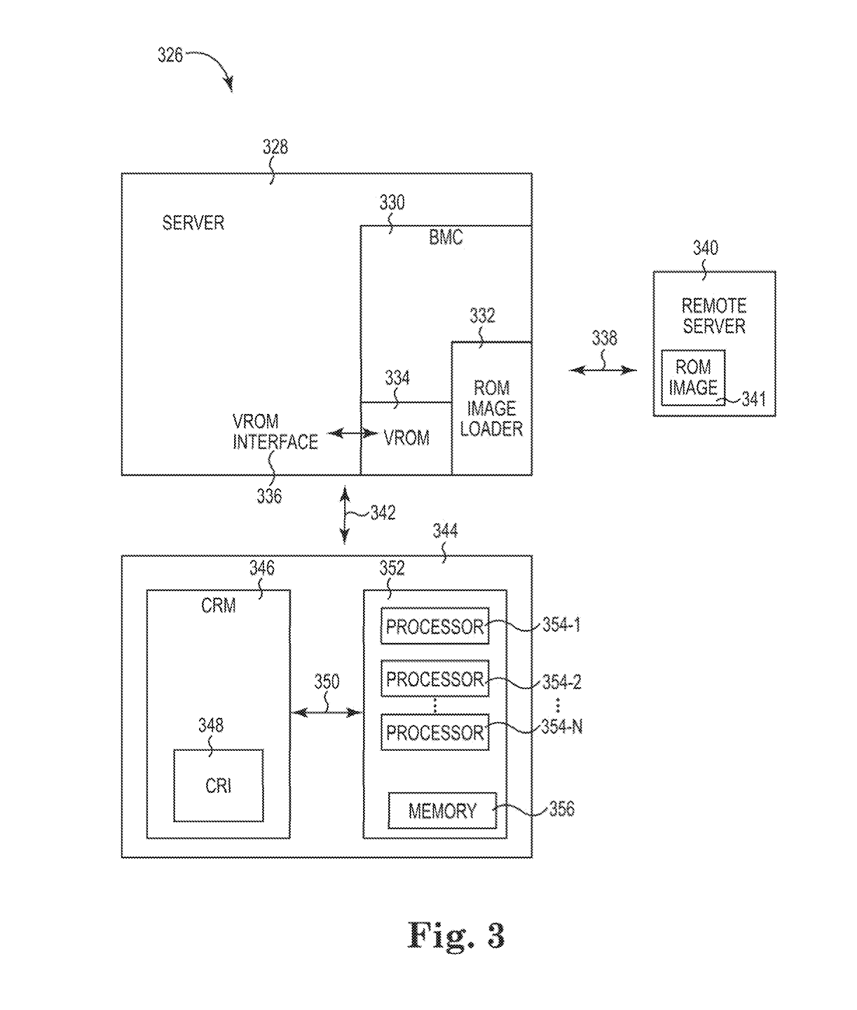

FIG. 3 illustrates a block diagram of an example of a system 326 for booting a server 328 using a remote ROM image 341, according to the present disclosure. The system 326 can include a computer-readable medium (CRM) 346 in communication with processor resources 354-1, 354-2 . . . 354-N, for booting a server 328 using a remote ROM image 341. CRM 346 can be in communication with a computing device 352 (e.g., server, having processor resources of more or fewer than 354-1, 354-2 . . . , 354-N). The computing device 352 can be in communication with, and/or receive a tangible non-transitory CRM 346 storing a set of computer-readable instructions 348 executable by one or more of the processor resources 354-1, 354-2 . . . 354-N, as described herein. The computing device 352 can include memory resource 356, and the processor resources 354-1, 354-2 . . . 354-N can be coupled to the memory resource 356.

Processor resources 354-1, 354-2 . . . 354-N can execute computer-readable instructions 348 that can be stored on an internal or external non-transitory CRM 346. A non-transitory CRM (e.g., CRM 346), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), flash memory, etc., as well as other types of computer-readable media.

The non-transitory CRM 346 can be integral, or communicatively coupled, to a computing device 352, in either in a wired or wireless manner. For example, the non-transitory CRM 346 can be an internal memory, a portable memory, a portable disk, or a memory associated with another computing resource (e.g., enabling the computer-readable instructions to be transferred and/or executed across a network such as the Internet).

The CRM 346 can be in communication with the processor resources 354-1, 354-2 . . . 354-N via a communication path 350. The communication path 350 can be local or remote to a machine (e.g., a computer 352) associated with the processor resources 354-1, 354-2 . . . 354-N. Examples of a local communication path 350 can include an electronic bus internal to a machine such as a computer where the CRM 346 is one of volatile, non-volatile, fixed, and/or removable storage medium in communication with the processor resources 354-1, 354-2 . . . 354-N via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 350 can be such that the CRM 346 is remote from the processor resources e.g., 354-1, 354-2 . . . 354-N such as in the example of a network connection between the CRM 346 and the processor resources e.g., 354-1, 354-2 . . . 354-N. That is, the communication path 350 can be a network connection, Examples of such a network connection can include a local area network (LAN), a wide area network (WAN), a personal area network (PAN), and the Internet, among others. In such examples, the CRM 346 can be associated with a first computing device and the processor resources 354-1, 354-2 . . . 354-N can be associated with a second computing device 352.

The processor resources 354-1, 354-2, . . . 354-N and CRM 346 can be integral, or communicatively coupled, to a server 328, in either in a wired or wireless manner. For example, the non-transitory CRM 346 and the processor resources 354-1, 354-2 . . . 354-N can be an internal memory of the server 328, a portable memory, a portable disk, or a memory associated with another computing resource 344 (e.g., enabling the computer-readable instructions to be transferred and/or executed across a network such as the Internet).

For instance, the processor resources 354-1, 354-2 . . . 354-N and CRM 346 can be associated with another computing resource 344. The computing resource 344 can be in communication with the server 328 via a communication path 342 The communication path 342 can be local or remote to a machine (e.g., a computer) associated with the server 328.

The communication path 342 can be such that the CRM 346 and processor resources 354-1, 354-2 . . . 354-N are remote from the server 328 such as in the example of a network connection between the CRM 346 and the processor resources e.g., 354-1, 354-2 . . . , 354-N and the server 328. That is the communication path 342 can be a network connection. Examples of such a network connection can include a local area network (LAN), a wide area network (WAN), a personal area network (PAN), and the Internet, among, others. In such examples, the CRM 346 and, processor resources 354-1, 354-2 . . . 354-N can be associated with a first computing device 344 and the server 328 can be associated with a second computing device.

The, processor resources 354-1, 354-2 . . . 354-N coupled to the memory 356 can retrieve BMC configuration information stored on a BMC 330 on a server 328 and associated with the boot operation of the server 328. The processor resources 354-1, 354-2 . . . 354-N coupled to the memory 356 can access, from a remote server 340, a remote ROM image 341, load the remote ROM image 341 onto a memory on the BMC 330, and validate the remote ROM image 341 based on a comparison of the remote ROM image 341 to the BMC configuration information. The remote ROM image 341 can be accessed via a communication path 338. The communication path 338 can include, for example, web server, FTP, or NFS protocol between the server 328 and the remote server 340. A ROM image loader module 332 located on the BMC 330 can be used to access, load, and validate the remote ROM image 341.

The processor resources 354-1, 354-2 . . . 354-N coupled to the memory 356 can determine if the server 328 is booting when the remote ROM image 341 is accessed. In response to determining the server 328 is booting, the processor resources 354-1, 354-2 . . . 354-N coupled to the memory 356 can boot the server 328 from the remote ROM image 341 with a server hardware using a hardware VROM interface 335. Booting the server 328 can include releasing server reset and placing the server 328 in a fully operable state, for example. The remote ROM image 341 used to boot the server 328 can be located on memory on the BMC 330. For example, the remote ROM image 341 can be located on a VROM 334 on the BMC 330. The hardware VROM interface 336 can map hardware on the server 28 to the VROM 334 such that the server 328 is booting from memory on the BMC 330 while functioning as if booting from physical memory on the server 328. In various examples of the present disclosure, the ROM image loader module 332 located on the BMC 330 can be used to create the hardware VROM interface 336 and boot the server 328 using the remote ROM image 341.

In some examples of the present disclosure, in response to the server 328 booting to a fully operable state the processor resources 354-1, 354-2 . . . 354-N coupled to the memory 356 can place the server 328 on a reset state in response to a server reset.

In some examples of the present disclosure, the processor resource 354-1, 354-2 . . . 354-N coupled to the memory 356 can determine if the server 328 is running when the remote ROM image 341 is accessed. In response to determining the server 328 is running, the processor resources 354-1, 354-2 . . . 354-N coupled to the memory 356 can place the server 328 on a reset state in response to a server reset.

in various examples of the present disclosure, the processor resources 354-1, 354-2 . . . 354-N coupled to the memory 356 can use a pre-validated ROM image stored on the BMC 330 memory to begin booting the server 328. The pre-validated ROM image can include a ROM image that is smaller than the remote ROM image 341, for example. For instance, the pre-validated ROM image can include a 128 Kilobyte image located on the BMC 330 firmware that can be guaranteed to be valid. The pre-validated ROM image can include a ROM image that can begin the boot process for the server 328 but is insufficient to complete the boot process, for example.

The above specification, examples, and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method for booting a first server using a remote read-only memory (ROM) image, comprising;
accessing a remote ROM image from a second server for the first server, wherein the first server does not have a complete ROM image;
storing the remote ROM image in a subsystem memory; and
booting the first server from the remote ROM image in the subsystem memory.

2. The method of claim 1, wherein storing the remote ROM image includes storing the remote ROM image in a baseboard management controller (BMC) memory.

3. The method of claim 1 wherein accessing the remote ROM image includes accessing the remote ROM image over a network.

4. The method of claim 1, wherein accessing the remote ROM image further includes retrieving, configuration information associated with the boot operation of the first server, wherein the configuration information includes the second server access information.

5. The method of claim 1, wherein booting the first server from the remote ROM image in the subsystem memory further includes creating an interface on the first server to map the remote ROM image in the subsystem memory to a first server hardware.

6. A non-transitory computer readable-medium storing a set of instructions executable by a processor to cause a device to:
retrieve baseboard management controller (BMC) configuration information stored on a BMC located on a server and associated with the boot operation of the server;
detect a remote read-only memory (ROM) image on a remote server;
load the remote ROM image onto a memory on the BMC;
validate the remote ROM image based on the BMC configuration information;
create a hardware virtual ROM (VROM) interface; and
boot the server from the remote ROM image on the BMC memory using the VROM interface.

7. The non-transitory computer readable-medium of claim 6, wherein the instructions are further executable to create a VROM on the BMC with the remote ROM image.

8. The non-transitory computer readable-medium of claim 6, wherein the instructions to validate the remote ROM image are further executable to compare the remote ROM image to the BMC configuration information to determine if the remote ROM image can be used for system boot of the server.

9. The non-transitory computer readable-medium of claim 6, wherein the instructions are further executable to repeat detecting and loading the remote ROM image in response to the remote ROM image being invalid.

10. A system for server boot with a remote read-only memory (ROM) image, comprising:
processor resources; and
a memory coupled to the processor resources and configured to direct the processor to:
retrieve baseboard management controller (BMC) configuration information stored on a BMC on a server and associated with the boot operation of the server;
access, from a remote server, a remote ROM image;
load the remote ROM image onto a memory on the BMC;
validate the ROM image based on a comparison of the ROM image to the BMC configuration information;
determine if the server is booting when the remote ROM image is accessed; and
in response to determining the server is booting, boot the server from the remote ROM image with a server hardware using a hardware virtual ROM interface.

11. The system of claim 10, wherein the memory is further configured to direct the processor resources to place the server on a reset state in response to a server reset.

12. The system of claim 10, wherein the memory is further configured to direct the processor resources to register the BMC memory location of the remote ROM image.

13. The system of claim 10, wherein the memory is further configured to direct the processor resources to:
determine if the server is running when the remote ROM image is accessed; and
in response to determining the server is running, place the server on a reset state in response to a server reset.

14. The system of claim 10, wherein the memory is further configured to direct the processor resources to register the remote server location of the remote ROM image.

15. The system of claim 10, wherein the memory is further configured to direct the processor resources to use a pre-validated ROM image stored on the BMC memory to begin booting the server.
